(19) United States
(12) Patent Application Publication
(10) Pub. No.: US 2026/0119666 A1
(43) Pub. Date: Apr. 30, 2026

(54) RECOVERY FROM MALICIOUS SOFTWARE

(71) Applicant: Arms Cyber Defense, Inc., Franklin, TN (US)

(72) Inventors: Bradley David Potteiger, Baltimore, MD (US); Michael Charles Bryant, Brentwood, TN (US); Timothy Ryan Potteiger, Baltimore, MD (US); Jason Royer Dean, Clarksville, TN (US)

(21) Appl. No.: 18/926,125

(22) Filed: Oct. 24, 2024

(51) Int. Cl. G06F 21/56

(52) U.S. Cl. CPC G06F 21/568; G06F 2221/034

(57) ABSTRACT

Various embodiments of methods, systems and computer program products described herein are directed to a Recovery Engine. The Recovery Engine saves a backup copy of a first file, the backup copy identified by a restoration filename. The Recovery Engine determines a first location of the first file from the restoration filename. The Recovery Engine replaces a modified version of the first file at the first location with the backup copy of the first file.

### BACKGROUND

With the rise of ransomware over the past several years, it is easier than ever for attackers to wreak havoc on unsuspecting organizations. This damage has expanded from government organizations to large enterprises to small businesses alike. A foundational principle behind these attacks is the concept of a ransom payment. By encrypting user files on the endpoint to render them inaccessible, attackers can hit on organizational pain points such as loss of business, system downtime, and safety concerns. Attackers today hope that the longer these pain points last for these organizations, the more likely they will pay the attackers a ransom payment to unencrypt the files. This makes the ransom payment the lifeblood of the attacker, allowing them to survive from a business perspective. Without these payments, attackers wouldn't have the incentive to execute these types of attacks. Most businesses assume that by paying the ransom payment, they can quickly wipe their hands of the attack and move on, but a lot of the time the true cost is magnitudes of this initial number after combining the total direct and indirect factors.

### SUMMARY

Conventional data recovery methods for post-ransomware encryption focus on restoring access to compromised data through various techniques. These techniques can be broken down into three primary categories: decryption-based recovery, volume shadow copy service-based recovery, and backup-based recovery. Each offers distinct advantages and drawbacks with considerations spanning disk usage, reliability, and comprehensiveness of restore.

One decryption-based recovery method is Encryption Key Capture which involves intercepting keys during an attack, enabling rapid decryption without paying a ransom. This method is highly effective if the keys can be captured in real-time but requires sophisticated detection tools and is only viable if deployed during the encryption process. Similarly, Pre-Stored Decryption Keys rely on a library of keys collected from previous incidents, allowing for swift recovery against known ransomware strains. However, this approach fails against new or altered variants for which no key exists, offering no protection against evolving ransomware strains.

Volume Shadow Copy Service (VSS) Utilization provides an additional layer of recovery by allowing users to roll back to previous system states. While effective when intact, many sophisticated ransomware strains actively delete VSS copies, limiting its usefulness. Controlled Folder Access, which prevents unauthorized applications from modifying files in protected directories, serves more as a preventive measure than a recovery solution.

Restoring from Backups is one of the most reliable methods for data recovery after a ransomware attack, provided that recent and secure backups are available. This process involves retrieving and restoring data from previously created backup copies, enabling a quick return to normal operations. However, it is only effective if the backups are intact and uncorrupted. In contrast, Automatic Backups focus on the routine, automated creation of backup copies at regular intervals, ensuring that data is continuously protected and up-to-date. While this proactive measure is essential for maintaining data integrity, it can be compromised if ransomware specifically targets and deletes these backups.

Various embodiments of methods, systems and computer program products described herein are directed to a Recovery Engine. Embodiments of the Recovery Engine significantly improve conventional technologies by generating a backup copy of a file before a malicious program or ransomware has the opportunity to encrypt that file. The Recovery Engine thereby later replaces an encrypted version of the file with the backup copy.

According to various embodiments, the Recovery Engine saves a backup copy of a first file, the backup copy identified by a restoration filename. The Recovery Engine determines a first location of the first file from the restoration filename. The Recovery Engine replaces a modified version of the first file at the first location with the backup copy of the first file.

According to various embodiments, the Recovery Engine generates the restoration filename for the backup copy as a representation of the first location of the first file. It is understood that a backup copy of a file may be an archived instance of the file.

According to various embodiments, the Recovery Engine creates the restoration filename as having an encoded portion(s) of a path to the first location of the first file. For example, the restoration filename is based on the characters, letters and symbols that are included in a file path to a current location of the first file. The Recovery Engine does not alter the file path to the current location of the first file. Rather, the Recovery Engine applies an encoding pattern to copies of the characters, letters and symbols in the file path to the current location of the first file.

According to various embodiments, the Recovery Engine detects a modification of the first file. For example, the Recover Engine detects the first file has been encrypted by a malicious program or by ransomware.

According to various embodiments, in order to replace an encrypted first file with the backup copy of the first file, the Recovery Engine builds a path to the first location of the file by decoding on or more portions of the restoration filename.

According to various embodiments, after replacing the encrypted first file at the first location with the backup copy, the Recovery Engine determines a backup repository currently has an unlocked status and deletes the backup copy of the first file stored in the backup repository.

According to various embodiments, after replacing the encrypted first file at the first location with the backup copy, the Recovery Engine determines a backup repository currently has a locked status and keeps the backup copy of the first file stored in the backup repository.

According to various embodiments, the Recovery Engine locks the backup repository for a pre-define time range after a ransomware attack has been detected. For example, the pre-define time range may be 24 hours.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating an exemplary environment in which some embodiments may operate.

FIG. 2 is a diagram illustrating an exemplary environment in which some embodiments may operate.

FIG. 3A is a diagram illustrating an exemplary method that may be performed in some embodiments.

FIG. 3B is a diagram illustrating an exemplary method that may be performed in some embodiments.

FIG. 4 is a diagram illustrating an exemplary environment in which some embodiments may operate.

FIG. 5A is a diagram illustrating an exemplary environment in which some embodiments may operate.

FIG. 5B is a diagram illustrating an exemplary environment in which some embodiments may operate.

FIG. 6 is a diagram illustrating an exemplary environment in which some embodiments may operate.

In this specification, reference is made in detail to specific embodiments of the invention. Some of the embodiments or their aspects are illustrated in the drawings.

### DETAILED DESCRIPTION

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

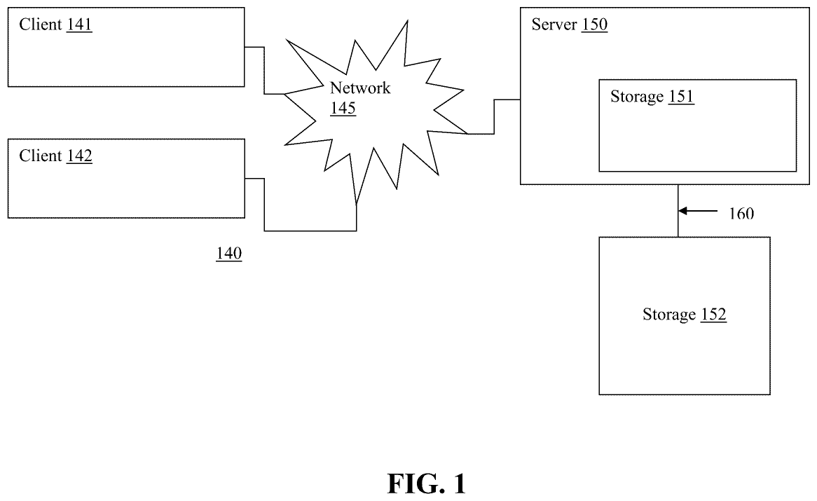

A diagram of exemplary network environment in which embodiments may operate is shown in FIG. 1. In the exemplary environment 140, two clients 141, 142 are connected over a network 145 to a server 150 having local storage 151. Clients and servers in this environment may be computers. Server 150 may be configured to handle requests from clients.

The exemplary environment 140 is illustrated with only two clients and one server for simplicity, though in practice there may be more or fewer clients and servers. The computers have been termed clients and servers, though clients can also play the role of servers and servers can also play the role of clients. In some embodiments, the clients 141, 142 may communicate with each other as well as the servers. Also, the server 150 may communicate with other servers.

The network 145 may be, for example, local area network (LAN), wide area network (WAN), telephone networks, wireless networks, intranets, the Internet, or combinations of networks. The server 150 may be connected to storage 152 over a connection medium 160, which may be a bus, crossbar, network, or other interconnect. Storage 152 may be implemented as a network of multiple storage devices, though it is illustrated as a single entity. Storage 152 may be a file system, disk, database, or other storage.

In an embodiment, the client 141 may perform the method 200 or other method herein and, as a result, store a file in the storage 152. This may be accomplished via communication over the network 145 between the client 141 and server 150. For example, the client may communicate a request to the server 150 to store a file with a specified name in the storage 152. The server 150 may respond to the request and store the file with the specified name in the storage 152. The file to be saved may exist on the client 141 or may already exist in the server's local storage 151. In another embodiment, the server 150 may respond to requests and store the file with a specified name in the storage 151. The file to be saved may exist on the client 141 or may exist in other storage accessible via the network such as storage 152, or even in storage on the client 142 (e.g., in a peer-to-peer system).

In accordance with the above discussion, embodiments can be used to store a file on local storage such as a disk or on a removable medium like a flash drive, CD-R, or DVD-R. Furthermore, embodiments may be used to store a file on an external storage device connected to a computer over a connection medium such as a bus, crossbar, network, or other interconnect. In addition, embodiments can be used to store a file on a remote server or on a storage device accessible to the remote server.

Furthermore, cloud computing is another example where files are often stored on remote servers or remote storage systems. Cloud computing refers to pooled network resources that can be quickly provisioned so as to allow for easy scalability. Cloud computing can be used to provide software-as-a-service, platform-as-a-service, infrastructure-as-a-service, and similar features. In a cloud computing environment, a user may store a file in the “cloud,” which means that the file is stored on a remote network resource though the actual hardware storing the file may be opaque to the user.

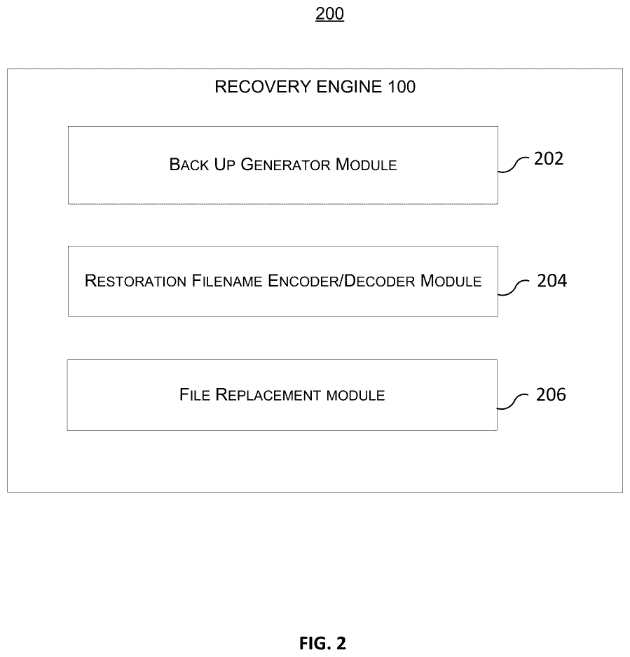

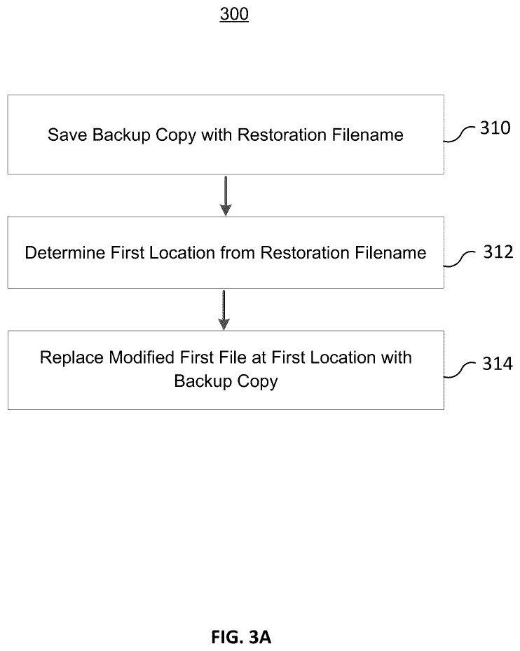

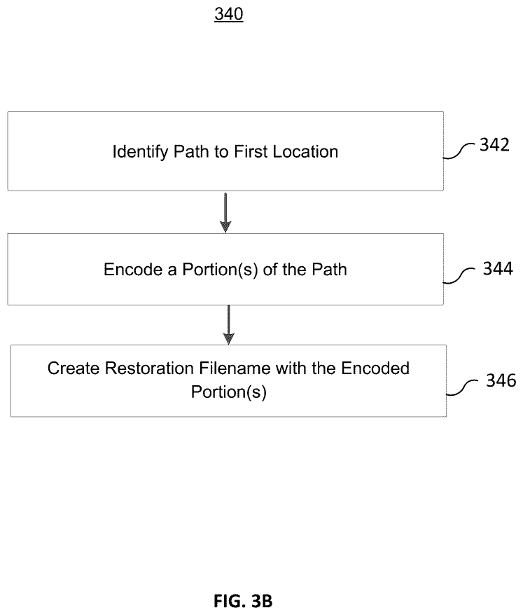

FIG. 2 illustrates a block diagram of an example system 200 for a Recovery Engine that includes a backup generator module 202, a decoder/encoder module 204 and a file replacement module 206. Module 202 may perform functionality as illustrated in FIGS. 3A, 3B, 4, 5A and 5B. Module 204 may perform functionality as illustrated in FIGS. 3A, 3B, 4, 5A and 5B. Module 206 may perform functionality as illustrated in FIGS. 3A, 3B, 4, 5A and 5B.

As shown in flowchart 300 in FIG. 3A, the Recovery Engine saves a backup copy of the first file and names the backup copy according to the restoration filename. (Step 310) The Recovery Engine detects a file system operation request to open the first file and generates the restoration filename as a representation of the first location of the first file. For example, prior to initiation of an open file operation on the first file, the Recovery Engine intercepts an open file operation request associated with the first file.

In response to intercepting the open file operation request, the Recovery Engine determines whether there is an absence of a previously generated backup copy of the first file in a backup repository. If the Recovery Engine validates that no previously generated backup copy of the first file is currently saved in the backup repository, it proceeds to create and save a backup copy based on a current version of the first file. The current version of the first file will be an non-encrypted version of the first file because the Recovery Engine determines whether to save a backup copy by intercepting the open file operation request.

The Recovery Engine determines the first location of the first file from the restoration filename. (Step 312) The Recovery Engine detects that the first file has been modified. The Recovery Engine builds a path to the first location of the first file by decoding on or more portions of the restoration filename. The Recovery Engine identifies first location according to the built path.

The Recovery Engine replaces a modified version of the first file at the first location with the backup copy of the first file. (Step 314) After replacing the modified version of the first file at the first location with the backup copy of the first file, the Recovery Engine determines the backup repository currently has a locked status. Based on the on the locked status, the Recovery Engine keeps the backup copy of the first file stored in the backup repository. However, if the Recovery Engine determines the backup repository currently has an unlocked status, the Recovery Engine deletes the backup copy of the first file stored in the backup repository.

As shown in diagram 340 of FIG. 3B, the Recovery Engine identifies a path to the first location at which the first location is stored. (Step 342) For example, the Recovery Engine determines a current file system storage location at which the first file is stored.

The Recovery Engine encodes one or more portions of the path to the first location. (Step 344) The Recovery Engine modifies at least a portion of the path according to a pre-defined encoding pattern. For example, the encoding pattern may include inserting one or more special characters at pre-defined path positions. The encoding pattern may include reordering of one or more elements (such as characters) present in the path. The encoding pattern may include replacing one or more elements (such as characters) present in the path with predetermined replacement characters. It is understood that the Recovery Engine does not change the actual path to the first location. Rather, the Recovery Engine copies the characters of the actual path and then applies the encoding pattern to the copy of the actual path in order to create the restoration filename.

The Recovery Engine creates the restoration filename as included the one or more encoded portions of the path. (Step 346) After creating a permutation of the path to the first location of the first file according to the encoding pattern, the Recovery Engine creates the restoration filename based on the permutation of the path.

Various embodiments of the Recovery Engine may include one or more components, such as a File Supervisor, a File IO Filter, a Decision Module, and a Hidden Backup repository. The File Supervisor component may implement configuration and policy processes as well as relay information to the other components identifying which files to monitor and defining conditions that trigger backup events. These policies may be adjusted based on real time risk profiles. For example, according to a first policy, data files may be archived on a first write event within a 24 hour period. The first policy may result in limiting the amount of storage and constrain performance but will enable the maintenance of critical information in the event of an unexpected encryption event. However, if more real time data requirements are presented, the time period between file backups may become an hour or less, increasing the amount of interventions of the backup scheme. The File IO filter is a kernel module that monitors the input and output operations of files. The filter may be configured to filter events relates to files with specific file extensions and file at locations for the purpose of fine tuning an archival strategy. The decision module may be situated in user space process and is implemented to decide if it is necessary to create backup of a target file. The Recovery Engine may trigger initiation of the decision module in response to detecting an open an/or pre-write kernel event meaning that an object or process is attempting to write to a target file. A hidden backup repository may be part of the Recovery Engine for storing the archived files (i.e. backup copies of respective files). The repository is not accessible to users and attackers (i.e. unauthorized processes or programs) through the use of a kernel level filesystem filter driver. Files within this repository are compressed and mapped to their original paths for the minimization of storage space and speed or recovery.

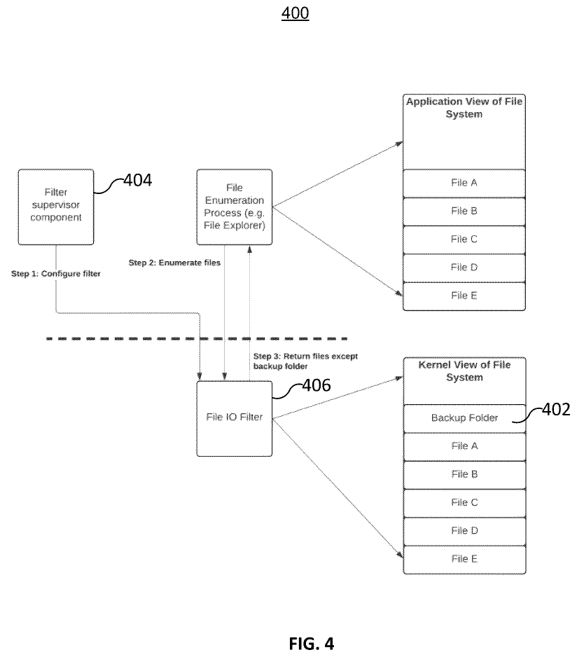

As shown in the diagram 400 of FIG. 4, the Recovery Engine ensures that a backup repository 402 (such as a “Backup Folder”) remains free from being tampered. The supervisor component 404 may send configuration instructions to a kernel level filesystem filter 406. The Recovery Engine has the capability of hiding filesystem resources due to its kernel level filesystem filter 404 intercepting every input or output request. For example, the filter 404 intercepts and prevents any operating system request from receiving an indication of presence the backup folder 402. The only case where this will not be true is if the calling process is among the respective protection processes of the Recovery Engine. For example, as an unauthorized process or ransomware software program navigates the filesystem with a file explorer, the backup repository 402 will effectively become a ghost resource that cannot be accessed by the unauthorized process or ransomware software program.

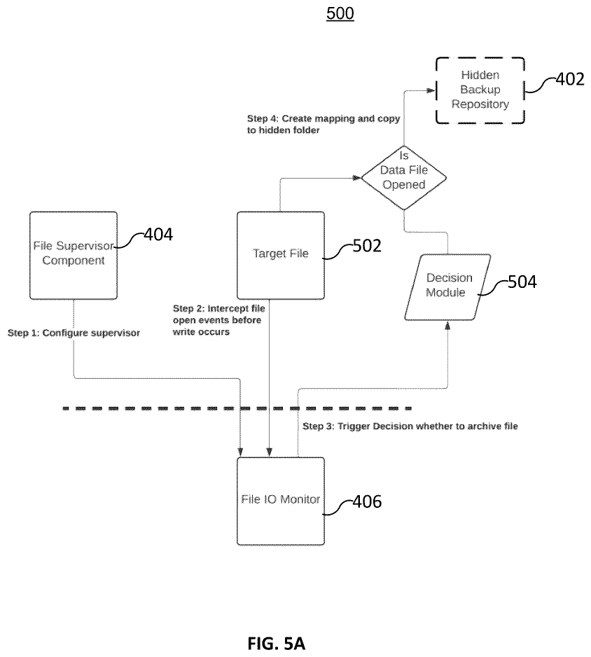

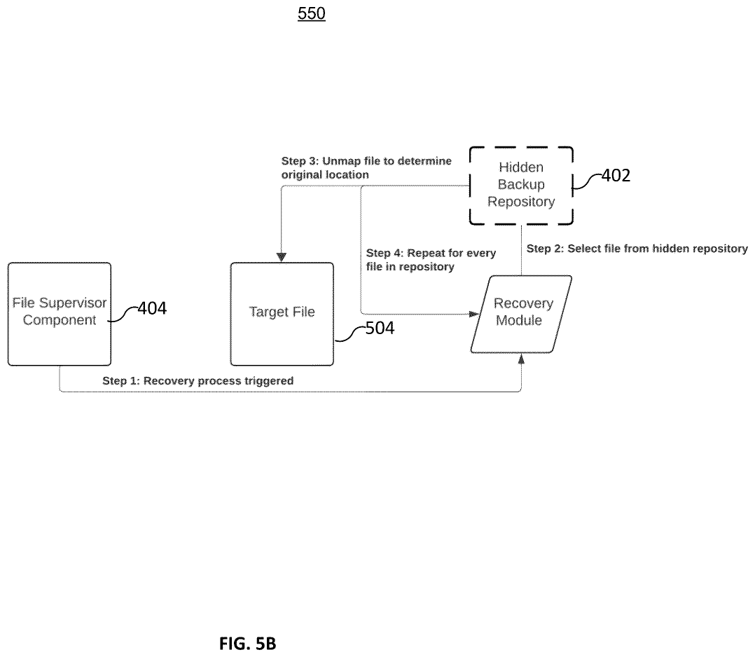

As shown in the diagram 500 of FIG. 5A, to mitigate the effects of encryption, archival of key files is necessary before any respective encryption process takes place. The kernel level filesystem filter driver 406 acts as a file IO monitor that intercepts and reviews all input/output requests from the filesystem. For example, when an open and pre-write event related to a target file 502 is received by the filter driver 406. The filter driver 406 prompts the decision module 504 in user space to determines if the target file 502 has been backed up within a predetermined period of time. A default period of time may be 24 hours. If it hasn't been backed up (i.e. archived) then the Recovery Engine places a backup copy of the target file 502 in the hidden backup repository 402. The Recovery Engine maps the original path to a current location of the target file 502 into file path metadata stored within the backup copy of the target file. For example, the Recovery Engine may encode the file path metadata and set the resulting encoded data as a restoration filename for the backup copy of the target file.

In some embodiments, the backup copy of the target file may be compressed. After the backup copy of the target file is placed in the hidden backup repository 402, the Recovery Engine allows for respective writes (and other operation requests) to be executed on the target file 502. If the target file 502 becomes encrypted by an unauthorized process or ransomware software program, the plain text form of the target file with the restoration filename will still exist in the hidden backup directory 402.

As shown in the diagram 550 of FIG. 5B, if an unauthorized process or ransomware software program does encrypt the target file 502, the Recovery Engine utilizes the backup copy of the target file to return the encrypted target file to its pre-attack state at the current location of the encrypted target file. In some embodiments, returning to pre-attack state may be triggered in response to a user request sent to the supervisor component 404. Based on the user request, the supervisor component 404 triggers one or more operations and components to iterate through one or more files archived in the hidden backup repository 402. For each backup copy of a file in the repository 402, the Recovery Engine extracts file path metadata to unmap the original file path name. For example, the Recovery Engine decodes the a backup copy's restoration filename to determine a file path to a current location of the target file 504. The Recover Engine accesses the current location of the encrypted target file and replaces the encrypted version with the target file's backup copy.

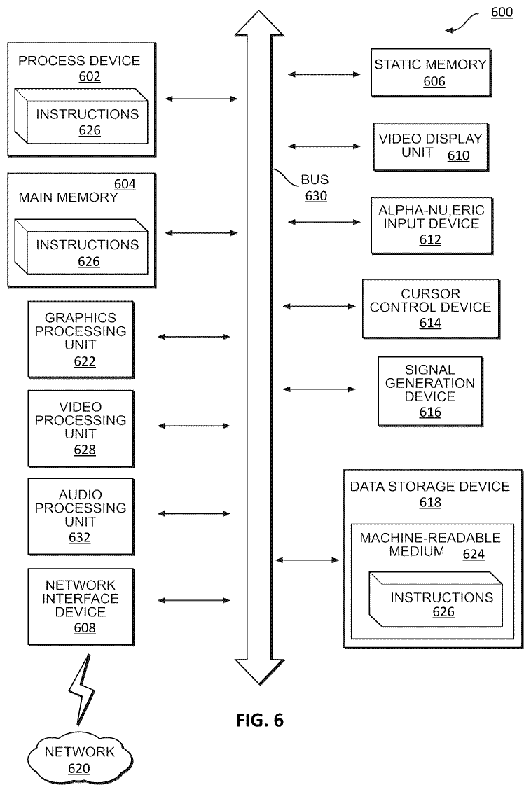

FIG. 6 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a computer-readable medium) on which is stored one or more sets of instructions or software 626 embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In one implementation, the instructions 626 include instructions to implement functionality corresponding to the components of a device to perform the disclosure herein. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method, comprising:
saving a backup copy of a first file, the backup copy identified by a restoration filename;
determining a first location from the restoration filename; and
replacing a modified version of the first file at the first location with the backup copy of the first file.

2. The computer-implemented method of claim 1, wherein saving a backup copy of a first file comprises:
detecting a file system operation request to open the first file; and
in response to detecting the file system operation request:
generating the restoration filename as a representation of the first location.

3. The computer-implemented method of claim 2, wherein detecting a file system operation request to open the first file comprises:
prior to initiation of an open file operation on the first file:
intercepting an open file operation request associated with the first file; and
in response to intercepting the open file operation request:
determining an absence of a previously generated backup copy of the first file.

4. The computer-implemented method of claim 2, wherein generating the restoration filename comprises:
identifying a path to the first location;
modifying at least a portion of the path according to a pre-defined encoding pattern; and
creating the restoration filename to at least include an encoded portion of the path.

5. The computer-implemented method of claim 1, wherein determining a first location from the restoration filename comprises:
detecting a modification of the first file;
building a path to a current location of the first file by decoding one or more portions of the restoration filename; and
identifying the first location according to the built path to the current location of the first file.

6. The computer-implemented method of claim 5, wherein detecting a modification of the first file comprises:
determining the first file has been encrypted by an unauthorized process; and
wherein replacing the modified version of the first file comprises:
replacing the encrypted first file with the backup copy of the first file.

7. The computer-implemented method of claim 1, further comprising:
after replacing the modified version of the first file at the first location with the backup copy of the first file:
determining a backup repository currently has an unlocked status; and
based on the on the unlocked status, deleting the backup copy of the first file stored in the backup repository.

8. The computer-implemented method of claim 1, further comprising:
after replacing the modified version of the first file at the first location with the backup copy of the first file:
determining a backup repository currently has a locked status; and
based on the on the locked status, keeping the backup copy of the first file stored in the backup repository.

9. A system comprising one or more processors, and a non-transitory computer-readable medium including one or more sequences of instructions that, when executed by the one or more processors, cause the system to perform operations comprising:
saving a backup copy of a first file, the backup copy identified by a restoration filename;
determining a first location from the restoration filename; and
replacing a modified version of the first file at the first location with the backup copy of the first file.

10. The system of claim 9, wherein saving a backup copy of a first file comprises:
detecting a file system operation request to open the first file; and
in response to detecting the file system operation request:
generating the restoration filename as a representation of the first location.

11. The system of claim 10, wherein detecting a file system operation request to open the first file comprises:
prior to initiation of an open file operation on the first file:
intercepting an open file operation request associated with the first file; and
in response to intercepting the open file operation request:
determining an absence of a previously generated backup copy of the first file.

12. The system of claim 10, wherein generating the restoration filename comprises:
identifying a path to the first file; and
modifying at least a portion of the path according to a pre-defined encoding pattern;
creating the restoration filename to at least include an encoded portion of the path.

13. The system of claim 9, wherein determining a first location from the restoration filename comprises:
detecting a modification of the first file;
building a path to a current location of the file by decoding one or more portions of the restoration filename; and
identifying the first location according to the built path to the current location of the first file.

14. The system of claim 13, wherein detecting a modification of the first file comprises:
determining the first file has been encrypted by an unauthorized process; and
wherein replacing the modified version of the first file comprises:
replacing the encrypted first file with the backup copy of the first file.

15. The system of claim 9, further comprising:
after replacing the modified version of the first file at the first location with the backup copy of the first file:
determining a backup repository currently has an unlocked status; and
based on the on the unlocked status, deleting the backup copy of the first file stored in the backup repository.

16. The system of claim 9, further comprising:
after replacing the modified version of the first file at the first location with the backup copy of the first file:
determining a backup repository currently has a locked status; and
based on the on the locked status, keeping the backup copy of the first file stored in the backup repository.

17. A computer program product comprising a non-transitory computer-readable medium having a computer-readable program code embodied therein to be executed by one or more processors, the program code including instructions to:
saving a backup copy of a first file, the backup copy identified by a restoration filename;
determining a first location from the restoration filename; and
replacing a modified version of the first file at the first location with the backup copy of the first file.

18. The computer program product of claim 17, wherein saving a backup copy of a first file comprises:
detecting a file system operation request to open the first file; and
in response to detecting the file system operation request:
generating the restoration filename as a representation of the first location of the first file.

19. The computer program product of claim 18, wherein detecting a file system operation request to open the first file comprises:
prior to initiation of an open file operation on the first file:
intercepting an open file operation request associated with the first file; and
in response to intercepting the open file operation request:
determining an absence of a previously generated backup copy of the first file.

20. The computer program product of claim 18, wherein generating the restoration filename comprises:
identifying a path to the first location of first file;
modifying at least a portion of the path according to a pre-defined encoding pattern;
creating the restoration filename to at least include an encoded portion of the path;
wherein determining a first location of the first file from the restoration filename comprises:
detecting encryption of the first file;
building the path to the first location of the file by decoding on or more portions of the restoration filename; and
identifying the first location according to the built path.
